(19) United States
(12) Patent Application Publication
(10) Pub. No.: US 2025/0370479 A1
(43) Pub. Date: Dec. 4, 2025

(54) EFFICIENTLY AND ACCURATELY MONITORING AGGREGATE CONFORMANCE WITH OPERATIONAL INTENTS FOR A FLEET OF UNMANNED AERIAL VEHICLES

(71) Applicant: Wing Aviation LLC, Palo Alto, CA (US)

(72) Inventors: Tara Rezvani, Los Gatos, CA (US); Leslie Williams, Palo Alto, CA (US); Reinaldo Negron, San Francisco, CA (US); Maryam Amer, San Diego, CA (US); Richard Allen, Fernandina Beach, FL (US)

(21) Appl. No.: 18/747,228

(22) Filed: Jun. 18, 2024

Related U.S. Application Data
(60) Provisional application No. 63/652,568, filed on May 28, 2024.

(51) Int. Cl. G05D 1/692; B64U 10/10; G07C 5/00; G08G 5/00

(52) U.S. Cl. CPC G05D 1/692; B64U 10/10; G07C 5/008; G08G 5/55; G08G 5/57; B64U 2201/10

(57) ABSTRACT

In some embodiments, a computer-implemented method of efficiently and accurately monitoring aggregate conformance with operational intents for a fleet of unmanned aerial vehicles (UAVs) is provided. A computing system receives telemetry data and operational intents for a plurality of flights during a monitoring period. For each flight of the plurality of flights, the computing system compares the telemetry data associated with the flight to the operational intent associated with the flight; labels each data point of the telemetry data as conformant or non-conformant based on the comparing; and generates a set of excursions based on the labeled data points. The computing system determines a level of aggregate conformance based on the set of excursions, and performs one or more actions in response to the level of aggregate conformance.

### CROSS REFERENCE(S) TO RELATED APPLICATION(S)

This application claims the benefit of Provisional Application No. 63/652,568, filed May 28, 2024, the entire disclosure of which is hereby incorporated by reference herein for all purposes.

### TECHNICAL FIELD

This disclosure relates generally to unmanned aerial vehicles (UAVs), and in particular but not exclusively, relates to monitoring performance of UAVs with respect to conformance with operational intents.

### BACKGROUND

Unmanned aerial systems (UASes) are being deployed for an increasing number of applications, including gathering imagery, package delivery, and a variety of other applications. Some applications, including but not limited to package delivery, are typically implemented using fleets of unmanned aerial vehicles (UAVs) in order to increase capacity of the service. As the popularity of services supplied by fleets of UAVs grows, it is increasingly likely that more than one provider of UAV services will desire to operate in a given geographic area. While there are categories of airspace that are open to UAV operations, once multiple UAS service suppliers (USSes) are conducting beyond visual line of sight (BVLOS) operations within a given geographic area, a need arises to deconflict traffic between the UAVs from multiple USSes.

A standard, entitled “Standard Specification for UAS Traffic Management (UTM) UAS Service Supplier (USS) Interoperability,” was most recently published by ASTM International in March 2022 and was designated F3548 (hereinafter “the Standard,” and incorporated by reference herein in its entirety for all purposes). The Standard provides several techniques for USSes operating in a shared geographic area to deconflict traffic with each other. The Standard describes techniques for exchanging operational intents that include four-dimensional reservations of airspace within the shared geographic area. As long as UAVs remain within the four-dimensional reservations of airspace specified by the exchanged operational intents, all traffic should be successfully deconflicted and able to operate safely.

That said, it is likely that sensor drift, weather conditions, and/or other factors may cause UAVs to occasionally depart from the reserved airspace specified by the operational intents. Such departures are referred to as “excursions.” Acknowledging that real-world UAV performance is unlikely to be perfectly predictable, the Standard describes benchmarks for numbers of allowable excursions during flight operations within the shared geographic area. While the Standard provides benchmarks, the Standard is silent regarding how monitoring for aggregate compliance with the excursion benchmarks may be accomplished. As the number of UAVs within a fleet increases, the processing of telemetry data to monitor for and benchmark excursions becomes increasingly onerous. What is desired are techniques that efficiently and accurately monitor flight operations for aggregate conformance with operational intents.

### BRIEF SUMMARY

In some embodiments, a computer-implemented method of efficiently and accurately monitoring aggregate conformance with operational intents for a fleet of unmanned aerial vehicles (UAVs) is provided. A computing system receives telemetry data and operational intents for a plurality of flights during a monitoring period. For each flight of the plurality of flights, the computing system compares the telemetry data associated with the flight to the operational intent associated with the flight; labels each data point of the telemetry data as conformant or non-conformant based on the comparing; and generates a set of excursions based on the labeled data points. The computing system determines a level of aggregate conformance based on the set of excursions, and performs one or more actions in response to the level of aggregate conformance.

In some embodiments, a non-transitory computer-readable medium having logic stored thereon is provided. The logic, in response to execution by one or more processors of a computing system, causes the computing system to perform actions for efficiently and accurately monitoring aggregate conformance with operational intents for a fleet of unmanned aerial vehicles (UAVs). The actions comprise receiving, by the computing system, telemetry data and operational intents for a plurality of flights during a monitoring period; for each flight of the plurality of flights: comparing, by the computing system, the telemetry data associated with the flight to the operational intent associated with the flight; based on the comparing, labeling, by the computing system, each data point of the telemetry data as conformant or non-conformant; and generating, by the computing system, a set of excursions based on the labeled data points; determining, by the computing system, a level of aggregate conformance based on the set of excursions; and performing, by the computing system, one or more actions in response to the level of aggregate conformance.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a schematic diagram that illustrates a non-limiting example embodiment of a system according to various aspects of the present disclosure.

FIG. 2A and FIG. 2B illustrate a non-limiting example embodiment of an aerial vehicle or UAV, in accordance with an embodiment of the present disclosure.

FIG. 3 is a block diagram that illustrates additional components of a non-limiting example embodiment of a UAV according to various aspects of the present disclosure.

FIG. 4A and FIG. 4B are schematic illustrations of non-limiting examples of flights performed by UAVs in accordance with a given operational intent, according to various aspects of the present disclosure.

FIG. 5 is a block diagram that illustrates aspects of a non-limiting example embodiment of a conformance monitoring computing system according to various aspects of the present disclosure.

FIG. 6 is a flowchart that illustrates a non-limiting example embodiment of a method of efficiently and accurately monitoring aggregate conformance with operational intents for a fleet of unmanned aerial vehicles (UAVs), according to various aspects of the present disclosure.

FIG. 7 illustrates a non-limiting example embodiment of a subroutine for generating a set of excursions based on labeled data points of telemetry data for a flight, according to various aspects of the present disclosure.

FIG. 8A and FIG. 8B illustrate processing performed by a non-limiting example embodiment of the subroutine of FIG. 7 on example sequences of labeled data points.

### DETAILED DESCRIPTION

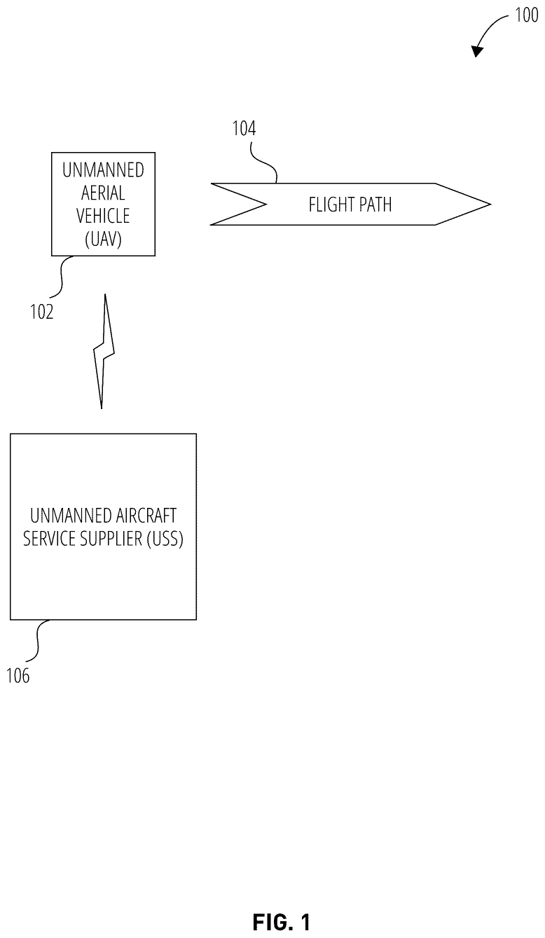

FIG. 1 is a schematic diagram that illustrates a non-limiting example embodiment of a system according to various aspects of the present disclosure. As shown, the 100 includes an unmanned aircraft service supplier (USS) 106 that controls a fleet of unmanned aerial vehicles (UAVs), including the illustrated UAV 102. The USS 106 provides a variety of computing systems and other devices that collectively provide mission planning, airspace reservation, strategic conflict management with other USSes operating in a shared geographic area, and other services that support the provision of services using UAVs.

When a mission for a UAV 102 is planned, the USS 106 determines a flight path 104 for the UAV 102, which is a four-dimensional volume of airspace to be reserved for use by the UAV 102 during a given time period. An indication of this four-dimensional volume of airspace is included in an operational intent. The operational intent is used by the USS 106 to coordinate with other USSes in order to manage strategic conflicts between UAVs operated by the other USSes, per the Standard.

In order for strategic conflict management to be effective, it is important for the UAV 102 to operate within the reserved flight path 104. The reserved flight path 104 is the safe area that has been cleared for use by the UAV 102, and areas outside of the reserved flight path 104 are of unknown safety with respect to conflicts with other UAVs. Accordingly, the UAV 102 collects telemetry data while it is performing an assigned mission associated with an operational intent. The telemetry data may then be used by the USS 106 to determine whether the UAV 102 remained within the reserved flight path 104 during the flight, or whether one or more excursions took place. The USS 106 may analyze the occurrences of excursions fleet-wide in order to determine whether a manual or automatic adjustment to the planning and/or execution of missions should take place.

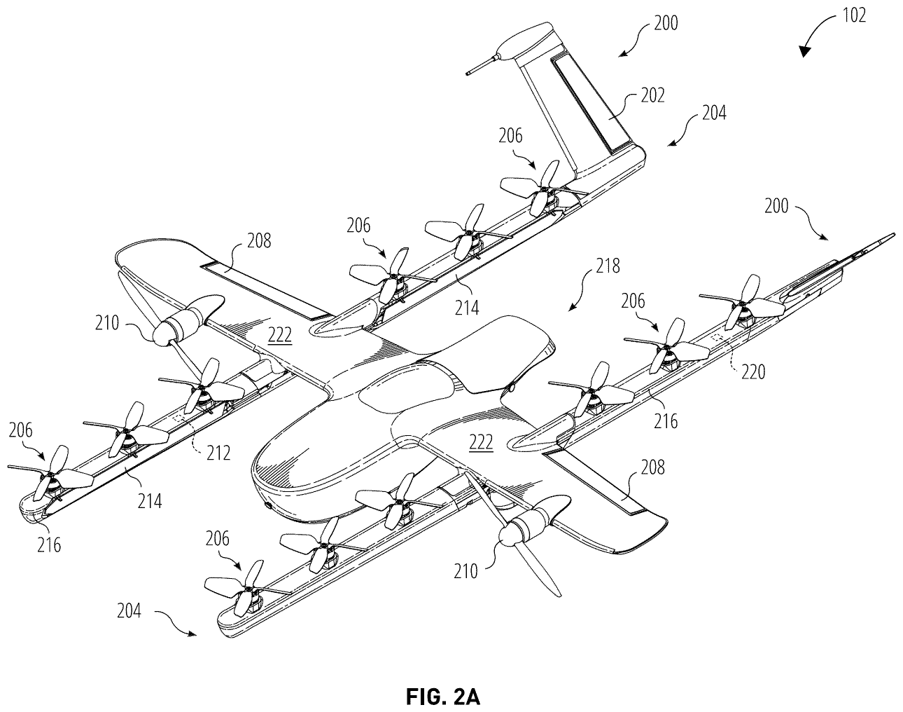

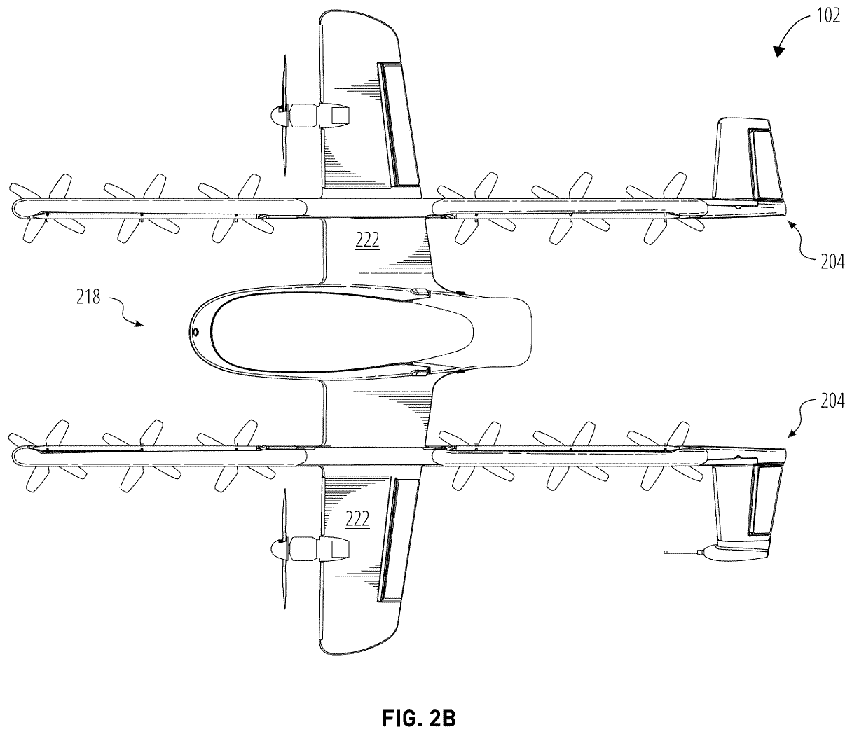

UAVs may take many different forms, including but not limited to fixed-wing configurations, rotary-wing configurations, and combinations thereof. Further, UAVs may include components for achieving a variety of mission types, including but not limited to one or more of sensing devices (e.g., cameras, LIDAR sensors, etc.), cargo-carrying apparatuses (e.g., a hook-and-tether, a cargo compartment, etc.), or presentation devices (e.g., lights, etc). FIG. 2A and FIG. 2B illustrate a non-limiting example embodiment of an aerial vehicle or UAV 102, in accordance with an embodiment of the present disclosure. The illustrated embodiment of UAV 102 is a vertical takeoff and landing (VTOL) unmanned aerial vehicle (UAV) that includes separate propulsion units 210 and propulsion units 206 for providing horizontal and vertical propulsion, respectively. UAV 102 is a fixed-wing aerial vehicle, which as the name implies, has a wing assembly 222 that can generate lift based on the wing shape and the vehicle's forward airspeed when propelled horizontally by propulsion units 210. FIG. 2A is a perspective top view illustration of UAV 102 while FIG. 2B is a bottom side plan view illustration of UAV 102.

The illustrated embodiment of UAV 102 includes a fuselage 218. In one embodiment, fuselage 218 is modular and includes a battery module, an avionics module, and a mission payload module. These modules are detachable from each other and mechanically securable to each other to contiguously form at least a portion of the fuselage 218 or UAV main body.

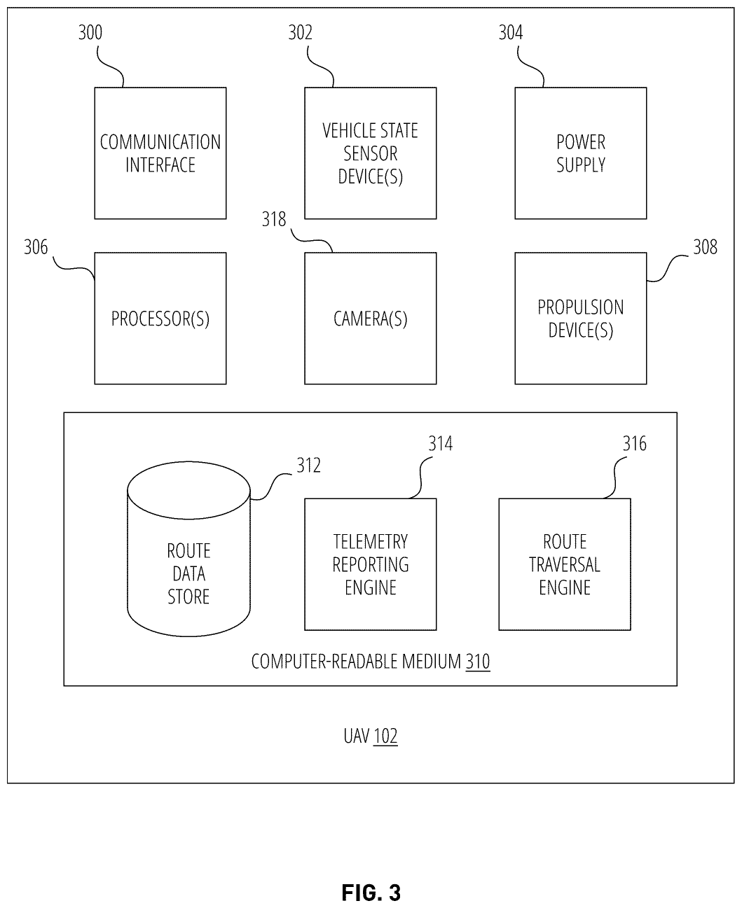

The battery module includes a cavity for housing one or more batteries for powering UAV 102. The avionics module houses flight control circuitry of UAV 102, which may include a processor and memory, communication electronics and antennas (e.g., cellular transceiver, Wi-Fi transceiver, etc.), and various sensors (e.g., global positioning sensor, an inertial measurement unit (IMU), a magnetic compass, etc.). The mission payload module houses equipment associated with a mission of UAV 102. For example, the mission payload module may include a payload actuator for holding and releasing an externally attached payload. In another embodiment, the mission payload module may include a camera/sensor equipment holder for carrying camera/sensor equipment (e.g., camera, lenses, radar, LIDAR, pollution monitoring sensors, weather monitoring sensors, etc.). Other components that may be carried by some embodiments of the UAV 102 are illustrated in FIG. 3.

The illustrated embodiment of UAV 102 further includes horizontal propulsion units 210 positioned on wing assembly 222, which can each include a motor, shaft, motor mount, and propeller, for propelling UAV 102. The illustrated embodiment of UAV 102 includes two boom assemblies 204 that secure to wing assembly 222.

The illustrated embodiments of boom assemblies 204 each include a boom housing 216 in which a boom is disposed, vertical propulsion units 206, printed circuit boards 214, and stabilizers 200. Vertical propulsion units 206 can each include a motor, shaft, motor mounts, and propeller, for providing vertical propulsion. Vertical propulsion units 206 may be used during a hover mode where UAV 102 is descending (e.g., to a delivery location) or ascending (e.g., following a delivery). Stabilizers 200 (or fins) may be included with UAV 102 to stabilize the UAV's yaw (left or right turns) during flight. In some embodiments, UAV 102 may be configured to function as a glider. To do so, UAV 102 may power off its propulsion units and glide for a period of time.

During flight, UAV 102 may control the direction and/or speed of its movement by controlling its pitch, roll, yaw, and/or altitude. For example, the stabilizers 200 may include one or more rudders 202 for controlling the UAV's yaw, and wing assembly 222 may include elevators for controlling the UAV's pitch and/or ailerons 208 for controlling the UAV's roll. As another example, increasing or decreasing the speed of all the propellers simultaneously can result in UAV 102 increasing or decreasing its altitude, respectively. The UAV 102 may also include components for sensing the environment around the UAV 102, including but not limited to audio sensor 220 and audio sensor 212. Further examples of sensor devices are illustrated in FIG. 3 and described below.

Many variations on the illustrated fixed-wing aerial vehicle are possible. For instance, aerial vehicles with more wings (e.g., an “x-wing” configuration with four wings), are also possible. Although FIG. 2A and FIG. 2B illustrate one wing assembly 222, two boom assemblies 204, two horizontal propulsion units 210, and six vertical propulsion units 206 per boom assembly 204, it should be appreciated that other variants of UAV 102 may be implemented with more or fewer of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

FIG. 3 is a block diagram that illustrates further components of a non-limiting example embodiment of a UAV according to various aspects of the present disclosure. As shown, the UAV 102 includes a communication interface 300, one or more vehicle state sensor devices 302, a power supply 304, one or more processors 306, one or more propulsion devices 308, and a computer-readable medium 310.

In some embodiments, the communication interface 300 includes hardware and software to enable any suitable communication technology for communicating with computing systems of the USS 106. In some embodiments, the communication interface 300 includes multiple communication interfaces, each for use in appropriate circumstances. For example, the communication interface 300 may include a long-range wireless interface such as a 4G or LTE interface, or any other type of long-range wireless interface (e.g., 2G, 3G, 5G, or WiMAX), to be used to communicate with the USS 106 while traversing a route. The communication interface 300 may also include a medium-range wireless interface such as a Wi-Fi interface to be used when the UAV 102 is at an area near a start location or an endpoint where Wi-Fi coverage is available. The communication interface 300 may also include a short-range wireless interface such as a Bluetooth interface to be used when the UAV 102 is in a maintenance location or is otherwise stationary and waiting to be assigned a route. The communication interface 300 may also include a wired interface, such as an Ethernet interface or a USB interface, which may also be used when the UAV 102 is in a maintenance location or is otherwise stationary and waiting to be assigned a route.

In some embodiments, the vehicle state sensor devices 302 are configured to detect states of various components of the UAV 102, and to transmit signals representing those states to other components of the UAV 102. Some non-limiting examples of vehicle state sensor device 302 include a battery state sensor and a propulsion device health sensor. The vehicle state sensor devices 302 may also include a global navigation satellite system (GNSS) sensor, one or more accelerometers (and/or other devices that are part of an inertial navigation system), LIDAR devices, and/or other sensor devices for sensing an environment of the UAV 102.

In some embodiments, the power supply 304 may be any suitable device or system for storing and/or generating power. Some non-limiting examples of a power supply 304 include one or more batteries, one or more solar panels, a fuel tank, and combinations thereof. In some embodiments, the propulsion devices 308 may include any suitable devices for causing the UAV 102 to travel along the path. For an aircraft, the propulsion device 308 may include devices such as, but not limited to, one or more motors, one or more propellers, and one or more flight control surfaces.

In some embodiments, the processor 306 may include any type of computer processor capable of receiving signals from other components of the UAV 102 and executing instructions stored on the computer-readable medium 310. In some embodiments, the computer-readable medium 310 may include one or more devices capable of storing information for access by the processor 306. In some embodiments, the computer-readable medium 310 may include one or more of a hard drive, a flash drive, an EEPROM, and combinations thereof.

In some embodiments, the one or more cameras 318 may include any suitable type of camera for capturing imagery from the point of view of the UAV 102. For example, the cameras 318 may include one or more of a downward-facing camera or an angled-view camera. In some embodiments, the one or more cameras 318 may include one or more cameras of any type, including but not limited to a visible light camera, an infrared camera, a light-field camera, a laser camera, and a time-of-flight camera.

As shown, the computer-readable medium 310 has stored thereon a route data store 312, a telemetry reporting engine 314, and a route traversal engine 316. In some embodiments, the route traversal engine 316 is configured to cause the propulsion device 308 to propel the UAV 102 through a route received from the USS 106 and stored in the route data store 312. The route traversal engine 316 may use signals from other devices, such as GPS sensor devices, vision-based navigation devices, accelerometers, LIDAR devices, and/or other devices that are not illustrated or described further herein, to assist in positioning and navigation as is typical for a UAV 102. In some embodiments, the telemetry reporting engine 314 is configured to collect telemetry data from the vehicle state sensor devices 302 and/or other components of the UAV 102, and to transmit the telemetry data to the USS 106.

As used herein, “engine” refers to logic embodied in hardware or software instructions, which can be written in one or more programming languages, including but not limited to C, C++, C #, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

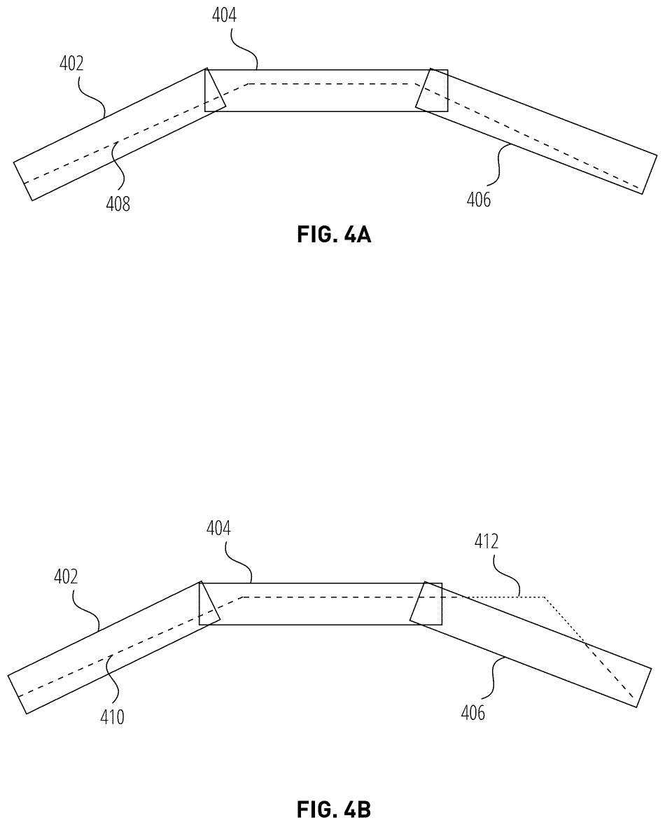

FIG. 4A and FIG. 4B are schematic illustrations of non-limiting examples of flights performed by UAVs in accordance with a given operational intent, according to various aspects of the present disclosure. The operational intent includes three reserved flight volumes for a first flight segment 402, a second flight segment 404, and a third flight segment 406. It is desired that the UAV executing the operational intent remains within these reserved flight volumes at all times. Though illustrated in two dimensions for the ease of depiction, one will recognize that the first flight segment 402, second flight segment 404, and third flight segment 406 may be four-dimensional shapes that define a volume and a time period during which the volume is reserved for the UAV associated with the operational intent. Also, one will recognize that while three flight segments are illustrated, operational intents may include more or fewer flight segments than those illustrated.

In FIG. 4A, a conformant flight path 408 is shown as a dotted line that passes through the first flight segment 402, the second flight segment 404, and the third flight segment 406. As may be expected, the conformant flight path 408 deviates from a center line of the reserved flight volumes due to conditions encountered during the flight, but because the conformant flight path 408 remains within the reserved flight volumes, this flight path is considered conformant for the entire duration.

In FIG. 4B, a non-conformant flight path 410 is shown. While the non-conformant flight path 410 starts out within the first flight segment 402 and the second flight segment 404, the UAV does not stay wholly within the third flight segment 406 (e.g., due to various environmental factors including but not limited to unexpected wind conditions, autonomous avoidance of an unforeseen obstacle, etc.), and results in an excursion 412 during which the UAV leaves the reserved flight volumes. In some embodiments of the present disclosure, excursions such as excursion 412 are detected from the telemetry data reported by UAVs within a fleet of UAVs controlled by the USS 106, and metrics are efficiently and accurately calculated to support taking remedial action when indicated.

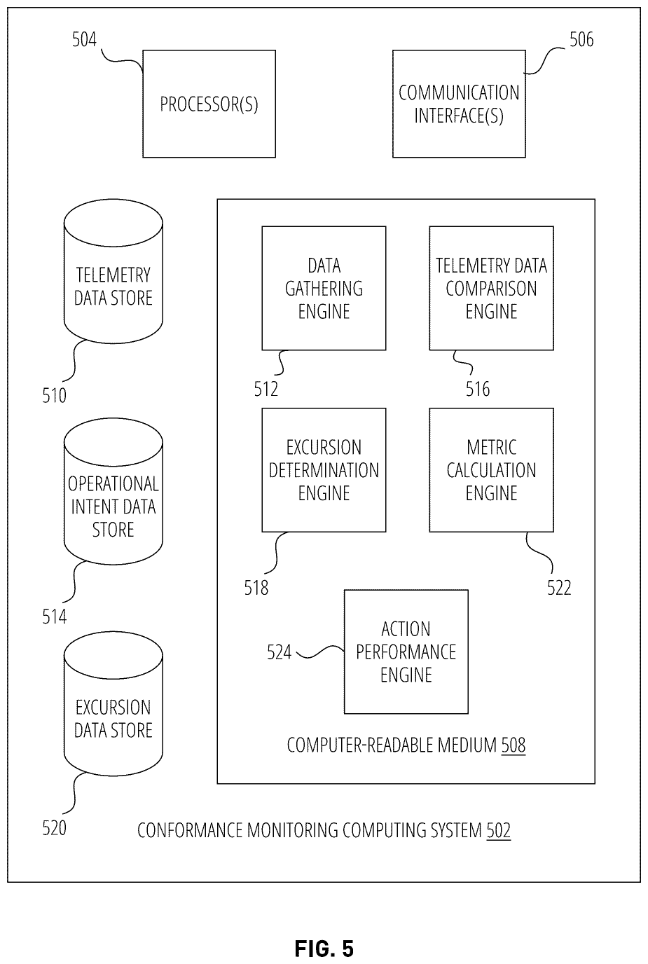

FIG. 5 is a block diagram that illustrates aspects of a non-limiting example embodiment of a conformance monitoring computing system according to various aspects of the present disclosure. The conformance monitoring computing system 502 is a component of the USS 106 that manages aggregate conformance monitoring for flights managed by the USS 106 and helps take action in response to various detected levels of conformance. The illustrated conformance monitoring computing system 502 may be implemented by any computing device or collection of computing devices, including but not limited to a desktop computing device, a laptop computing device, a mobile computing device, a server computing device, a computing device of a cloud computing system, and/or combinations thereof.

As shown, the conformance monitoring computing system 502 includes one or more processors 504, one or more communication interfaces 506, a telemetry data store 510, an operational intent data store 514, an excursion data store 520, and a computer-readable medium 508.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other optical disk storage; a magnetic cassette; a magnetic tape; and a magnetic disk storage.

In some embodiments, the processors 504 may include any suitable type of general-purpose computer processor. In some embodiments, the processors 504 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 506 include one or more hardware and or software interfaces suitable for providing communication links between components. The communication interfaces 506 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 508 has stored thereon logic that, in response to execution by the one or more processors 504, cause the conformance monitoring computing system 502 to provide a data gathering engine 512, a telemetry data comparison engine 516, an excursion determination engine 518, a metric calculation engine 522, and an action performance engine 524.

In some embodiments, the data gathering engine 512 is configured to receive operational intents from other components of the USS 106 and to store them in the operational intent data store 514. The data gathering engine 512 may also be configured to receive telemetry data generated by UAVs 102 and to store the telemetry data in the telemetry data store 510.

In some embodiments, the telemetry data comparison engine 516 is configured to compare telemetry data to corresponding operational intents, and to label data points within the telemetry data as being either conformant or non-conformant.

In some embodiments, the excursion determination engine 518 is configured to analyze the labeled data points generated by the telemetry data comparison engine 516 to group non-conformant data points into excursions.

In some embodiments, the metric calculation engine 522 is configured to determine one or more metrics from the excursions determined by the excursion determination engine 518 in order to determine a level of conformance for the USS 106.

In some embodiments, the action performance engine 524 is configured to perform actions in response to the determined level of conformance, as appropriate to the determined level.

Further description of the configuration of each of these components is provided below.

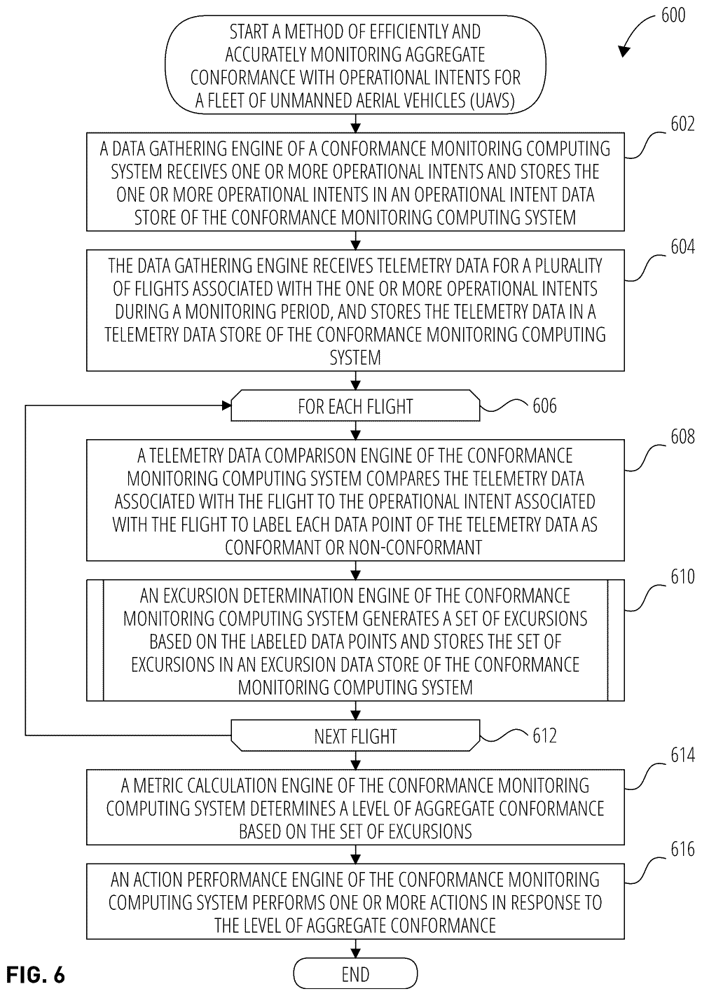

FIG. 6 is a flowchart that illustrates a non-limiting example embodiment of a method of efficiently and accurately monitoring aggregate conformance with operational intents for a fleet of unmanned aerial vehicles (UAVs), according to various aspects of the present disclosure. In the method 600, the conformance monitoring computing system 502 compares telemetry data generated by UAVs to their associated operational intents, and efficiently computes metrics that represent an amount of non-conformance within the fleet of UAVs.

From a start block, the method 600 proceeds to block 602, where a data gathering engine 512 of a conformance monitoring computing system 502 receives one or more operational intents and stores the one or more operational intents in an operational intent data store 514 of the conformance monitoring computing system 502. As described above, each operational intent includes at least one representation of a four-dimensional volume (a three-dimensional volume and a time period) in which its associated flight is expected to be located. Each operational intent may also include other information, including but not limited to an identifier of a UAV 102 from a fleet of UAVs assigned to the operational intent, an identifier of the operational intent that will be reported by the UAV along with the telemetry data, one or more actions to be performed by the UAV 102 during the flight other than navigation (e.g., package pickup or dropoff, data gathering, etc.), or other information. In some embodiments, the data gathering engine 512 may store a subset of the information from the operational intent in the operational intent data store 514 that is relevant to the actions performed in the method 600, and may discard other portions of the operational intent in order to conserve space within the operational intent data store 514 and improve efficiency. In some embodiments, instead of copying operational intents into the operational intent data store 514 within the conformance monitoring computing system 502, the data gathering engine 512 may retrieve operational intents as needed from an operational intent data store used by other components of the USS 106.

At block 604, the data gathering engine 512 receives telemetry data for a plurality of flights associated with the one or more operational intents during a monitoring period, and stores the telemetry data in a telemetry data store 510 of the conformance monitoring computing system 502. In some embodiments, the telemetry data received by the data gathering engine 512 may be for a predetermined monitoring period, such as an hour, day, a week, a month, or another predetermined monitoring period that is relevant to the operation of the USS 106 and/or reporting to regulatory bodies.

The telemetry data received by the data gathering engine 512 may include any telemetry information transmitted by the telemetry reporting engine 314, including but not limited to location data (or data from which a location may be inferred), imagery, actuator position data, accelerometer data, or battery state data. In some embodiments, the data gathering engine 512 may receive the telemetry data wirelessly from the UAV 102 while the flight is taking place. In some embodiments, the data gathering engine 512 may receive the telemetry data via a wired or wireless connection to the UAV 102 that is formed after the flight is complete. In some embodiments, the UAV 102 may transmit the telemetry data to another component of the USS 106, and the data gathering engine 512 may receive the telemetry data from the other component of the USS 106. Typically, the received telemetry data will include or be associated with an identifier that allows the telemetry data to be linked to its corresponding operational intent, and is typically provided as a time series of values.

As with the operational intents, the data gathering engine 512 may store all of the received telemetry data within the telemetry data store 510, or may store portions of the telemetry data relevant to aggregate conformance monitoring (e.g., time and location data) while discarding the rest in order to save storage space and improve efficiency. Likewise, in some embodiments, instead of copying the telemetry data into a separate telemetry data store 510 within the conformance monitoring computing system 502, the data gathering engine 512 may retrieve telemetry data as needed from a telemetry data store used by other components of the USS 106.

The method 600 then advances to a for-loop defined between a for-loop start block 606 and a for-loop end block 612, wherein the telemetry data from each flight represented by the telemetry data is processed.

From the for-loop start block 606, the method 600 proceeds to block 608, where a telemetry data comparison engine 516 of the conformance monitoring computing system 502 compares the telemetry data associated with the flight to the operational intent associated with the flight to label each data point of the telemetry data as conformant or non-conformant. In some embodiments, the telemetry data includes a time series of location values, such that each data point includes a time stamp and a location value. The comparison performed at block 608 may determine, for each data point of the telemetry data, an expected volume from the operational intent for the time stamp, and may label the data point as conformant or non-conformant based on whether the data point is within the expected volume. For example, in FIG. 4B, data points for the time stamps associated with the traversal of the first flight segment 402 and the second flight segment 404 may be labeled as conformant because the location values would be within the expected volumes (first flight segment 402 and second flight segment 404) at the corresponding times, and data points for the time stamps during the excursion 412 may be labeled as non-conformant because the location values are outside of the expected volume (third flight segment 406). In some embodiments, the telemetry data comparison engine 516 may add the labels to the telemetry data stored in the telemetry data store 510. In some embodiments, the telemetry data comparison engine 516 may create a separate record that associates the labels with the time stamps, without repeating the location information for the sake of efficiency.

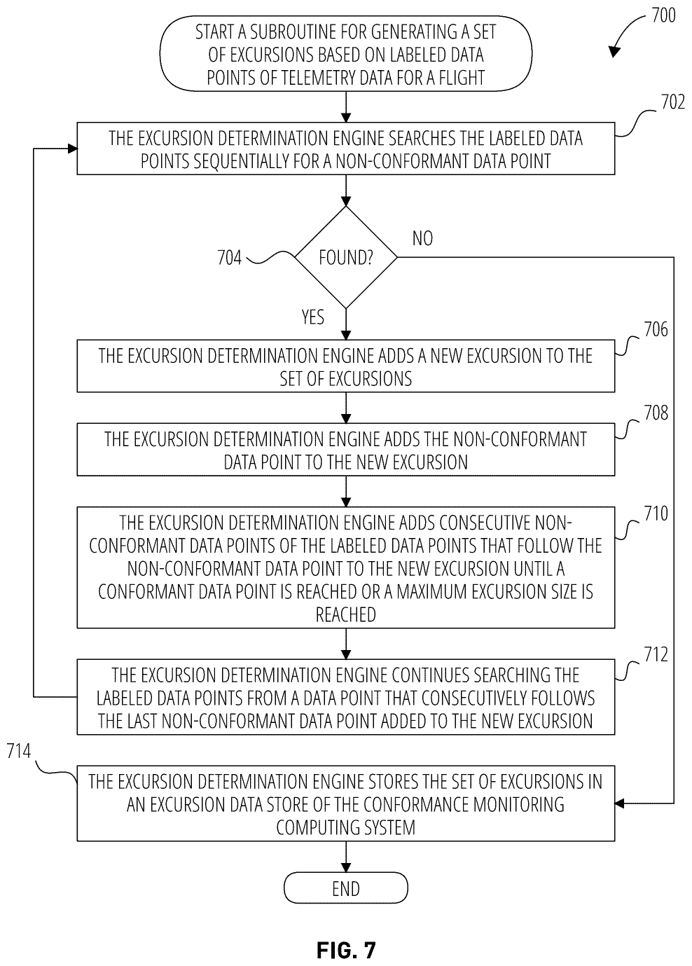

The method 600 then proceeds to a subroutine block 610, where a subroutine is performed wherein an excursion determination engine 518 of the conformance monitoring computing system 502 generates a set of excursions based on the labeled data points and stores the set of excursions in an excursion data store 520 of the conformance monitoring computing system 502. Each excursion of the set of excursions includes one or more consecutive labeled data points of the labeled data points that are labeled as non-conformant. Because the Standard is not explicit about how excursions should be measured, various different subroutines may be used to efficiently and accurately generate sets of excursions based on the labeled data points. One non-limiting example embodiment of such a subroutine is illustrated in FIG. 7 and described in further detail below.

The method 600 then advances to the for-loop end block 612. If further flights remain to be processed, then the method 600 returns from the for-loop end block 612 to the for-loop start block 606 to process the next flight. Otherwise, if all of the flights have been processed, then the method 600 advances from for-loop end block 612 to block 614.

At block 614, a metric calculation engine 522 of the conformance monitoring computing system 502 determines a level of aggregate conformance based on the set of excursions. The level of aggregate conformance represents how well all of the UAVs operated by the USS 106 conformed to their operational intents during the monitored period of time. In some embodiments, four levels of aggregate conformance may be defined: a non-conformance level, a near non-conformance level, a conformance level, and an over-conformance level. The non-conformance level indicates too much operation of UAVs outside of their agreed operational intents, and a higher-than-desired level of collision risk. If the non-conformance level is determined, it is likely that a remedial action may be forced upon the USS 106 by a regulator. The near non-conformance level indicates that while the non-conformance level has not yet been reached, the USS 106 may wish to take remedial action to avoid a negative regulatory action. The conformance level indicates a desired level of conformance to the operational intents, recognizing that some excursions are expected from time to time. The over-conformance level indicates that excursions are not happening as often as would be expected, and that the operational intents may be reserving more airspace than is fair for the USS 106 to reserve in light of other USSes wishing to operate flights in the shared geographic area.

In some embodiments, the metric calculation engine 522 may determine the level of aggregate conformance by comparing characteristics of the set of excursions to one or more thresholds. One non-limiting example of a characteristic that might be determined is a flight time conformance percentage. To determine a flight time conformance percentage, the metric calculation engine 522 may determine the elapsed time of each of the excursions of the set of excursions (e.g., by subtracting a timestamp of a first data point in the excursion from a timestamp of a last data point in the excursion, or using any other suitable technique). The metric calculation engine 522 may combine the elapsed times of each of the excursions to determine a total duration of excursions across all of the flights. The metric calculation engine 522 may also determine the elapsed time of each flight (e.g., by subtracting a timestamp of a first data point of telemetry data that is part of the flight from a timestamp of a last data point of telemetry data that is part of the flight, or using any other suitable technique), and combine the elapsed time of all of the included flights to determine the total number of flight hours (with conversions of units as appropriate). The metric calculation engine 522 may then divide the total duration of excursions by the total number of flight hours in order to determine the flight time conformance percentage.

Another non-limiting example of a characteristic that might be determined is a per-flight-hour excursion number. To determine a per-flight-hour excursion number, the metric calculation engine 522 may count the number of excursions in the set of excursions, and divide this number of excursions by the total number of flight hours as discussed above.

Once the characteristics are determined, the characteristics may be compared to thresholds associated with the various levels in order to assign a level of aggregate conformance. In some embodiments, when multiple characteristics are determined and compared to different thresholds, the lowest determined level of aggregate conformance may be assigned. In some embodiments, these thresholds may be configurable by the operator of the conformance monitoring computing system 502 to any suitable values, including but not limited to thresholds based on regulations or industry standards. One non-limiting example of thresholds and levels that may be used for a flight time conformance percentage is as follows:

| Level | Threshold |
|---|---|
| Non-conformance | <95% |
| Near Non-conformance | Between 95% and 97% |
| Conformance | Between 97% and 99.5% |
| Over-conformance | ≥99.5% |

One non-limiting example of thresholds and levels that may be used for a per-flight-hour excursion number is as follows:

| Level | Threshold |
|---|---|
| Non-conformance | 18 or more excursions per flight hour |
| Near Non-conformance | Between 16 and 18 excursions per flight hour |
| Conformance | Fewer than 16 excursions per flight hour |

In some embodiments, a level may be assigned based on comparisons to thresholds over a time period. For example, while a threshold may be assigned for over-conformance, in some embodiments, the USS 106 will not be considered to be operating at an over-conformance level unless the threshold is crossed for more than a predetermined amount of time, such as a rolling four-week period.

At block 616, an action performance engine 524 of the conformance monitoring computing system 502 performs one or more actions in response to the level of aggregate conformance. Any appropriate actions may be taken in response to the level of aggregate conformance. In some embodiments, the actions may include transmitting or presenting a notification of the determined level of aggregate conformance to an operator, a regulator, or another party to take action to address the determined level of aggregate conformance. For example, if a non-conformance level is determined, an operator may be directly notified in order to expeditiously address the non-conformance. In some embodiments, the actions may include automatically enabling or disabling functionality of the USS 106. For example, if the non-conformance level is maintained for more than a threshold amount of time, then the action performance engine 524 may send commands to one or more other devices of the USS 106 to automatically block the USS 106 from performing further flight planning and/or flight operations within the shared geographic area until the non-conformance is addressed.

In some embodiments, the action performance engine 524 may provide one or more interfaces that allow an operator to analyze the metrics as determined by the method 600. For example, the action performance engine 524 may store the level of aggregate conformance in a data store along with previously determined levels of aggregate conformance as historical information. The action performance engine 524 may then provide an interface that provides a dashboard for an operator to browse historical determinations of levels of aggregate conformance to determine trends over time, generate reports, determine correlations between non-conformance and various externalities, and/or for any other reason.

The method 600 then proceeds to an end block and terminates.

As the number of flights operated by a USS 106 increases and the number of flight hours during a monitoring interval also increases, the amount of telemetry data to be processed may quickly become quite large. Accordingly, it is desirable to use various techniques to improve the efficiency of the determination of the metrics that are the basis of the level of aggregate conformance determination. Characteristics of the definition of excursions may be used to help improve efficiency. For example, an excursion may be defined as having a maximum time, and if a flight is non-conformant for more than the maximum time, it will be considered more than one excursion. This could lead one to simplify the calculations by detecting the start of an excursion and then assuming that the excursion is the maximum time, jumping ahead in the telemetry data by the maximum time to search for the next excursion.

While this would save computation time, this calculation will be both under-inclusive and over-inclusive: the flight time conformance percentage metric will be over-inclusive (lower than a more accurate value), since even short excursions will be considered to take the maximum amount of time; and the per-flight-hour excursion number will be under-inclusive (lower than a more accurate value), because multiple short excursions may be combined into a single excursion. What is desired are techniques that allow for the efficient analysis of telemetry data in order to produce accurate excursion metrics.

FIG. 7 illustrates a non-limiting example embodiment of a subroutine for generating a set of excursions based on labeled data points of telemetry data for a flight, according to various aspects of the present disclosure. The subroutine 700 is a non-limiting example of a subroutine suitable for use at subroutine block 610 of FIG. 6, and would typically be performed by an excursion determination engine 518 of a conformance monitoring computing system 502, as described above.

From a start block, the subroutine 700 advances to block 702, where the excursion determination engine 518 searches the labeled data points sequentially for a non-conformant data point. Typically, the labeled data points are arranged in chronological order. The excursion determination engine 518 starts searching the labeled data points from the chronologically first labeled data point, and proceeds sequentially to search for a labeled data point that is labeled as being non-conformant.

The subroutine 700 then advances to a decision block 704, where a determination is made based on whether a non-conformant labeled data point was found. If all of the labeled data points were labeled as conformant, or if all of the labeled data points labeled as non-conformant have already been processed, then the excursion determination engine 518 would not find a non-conformant labeled data point.

If a non-conformant data point is found, then the result of decision block 704 is YES, and the subroutine 700 proceeds to block 706. At block 706, the excursion determination engine 518 adds a new excursion to the set of excursions, and at block 708, the excursion determination engine 518 adds the non-conformant data point to the new excursion. In some embodiments, to create the new excursion at block 706, the excursion determination engine 518 may initialize a data structure to hold the new excursion (e.g., a data structure that includes a linked list, a collection, or another type data structure for storing variable amounts of data). The non-conformant data point may then be added to the data structure at block 708. In some embodiments, the entire data point may be copied into the data structure. In some embodiments, the time stamp alone may be copied into the data structure. In some embodiments, the time stamp of this first non-conformant data point may also be stored as the start time of the excursion in the data structure.

At block 710, the excursion determination engine 518 adds consecutive non-conformant data points of the labeled data points that follow the non-conformant data point to the new excursion until a conformant data point is reached or a maximum excursion size is reached. Adding the consecutive non-conformant data points to the new excursion may include adding the consecutive non-conformant data points to the data structure initialized at block 706.

The maximum excursion size may be a predetermined length of time that is the maximum amount of time that a single excursion may take without being separated into more than one excursion. For example, a maximum excursion size of ten seconds may be used in some embodiments of the present disclosure, though in other embodiments, other maximum excursion sizes may be used. In some embodiments, the data points may be gathered at regular intervals, such that the excursion determination engine 518 may determine when the maximum excursion size is reached by counting the number of data points added to the new excursion. For example, if data points are gathered at a rate of one per second, and the maximum excursion size is ten seconds, then the excursion determination engine 518 may determine that the maximum excursion size is reached once ten data points have been added to the new excursion. In some embodiments, the data points may be gathered at irregular intervals, in which case the excursion determination engine 518 may determine that the maximum excursion size is reached by comparing a timestamp of a consecutive non-conformant data point to the timestamp of the first non-conformant data point to determine if it is inside or outside of the maximum excursion size.

At block 712, the excursion determination engine 518 continues searching the labeled data points from a data point that consecutively follows the last non-conformant data point added to the new excursion, and returns to block 702 to search for the next non-conformant data point.

Returning to decision block 704, if no further non-conformant data point has been found, then the result of decision block 704 is NO, and the subroutine 700 advances to block 714. At block 714, the excursion determination engine 518 stores the set of excursions in an excursion data store 520 of the conformance monitoring computing system 502. The subroutine 700 then ends and returns control to its caller.

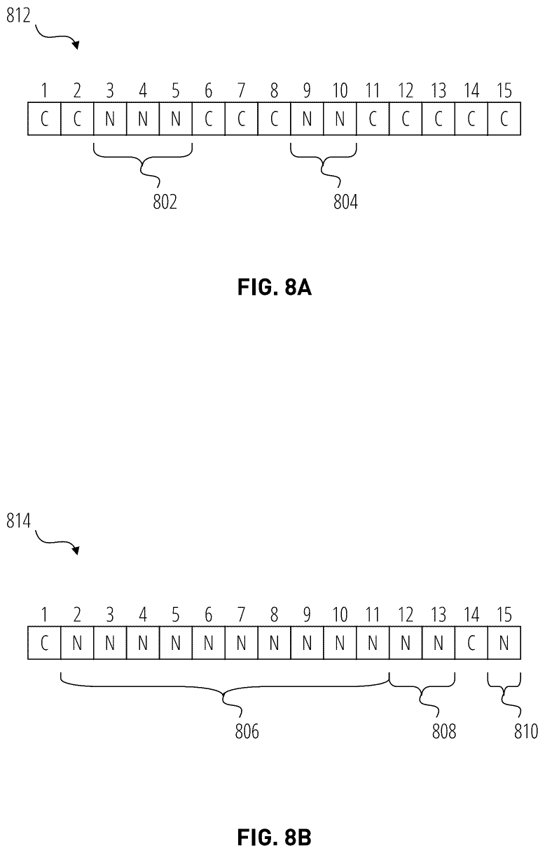

FIG. 8A and FIG. 8B illustrate processing performed by a non-limiting example embodiment of the subroutine of FIG. 7 on example sequences of labeled data points. In FIG. 8A and FIG. 8B, a first set of labeled data points 812 and a second set of labeled data points 814 are illustrated, respectively. Each data point includes a time index (t=0, 1, 2, . . . ) and a label of being conformant (“C”) or non-conformant (“N”). The illustrated sets of labeled data points represent a data rate of one per second, and a maximum excursion size of ten seconds is used. As such, the excursion determination engine 518 will add at most ten data points to any given excursion.

To process the first set of labeled data points 812 illustrated in FIG. 8A, the subroutine 700 searches from the start of the set (t=0) and searches sequentially until a non-conformant data point is found (block 702). Such a data point is found at index 3, and so a new excursion (first excursion 802) is created (block 706), and the data point at index 3 is added to the first excursion 802 (block 708). The subroutine 700 then adds the consecutive non-conformant data points that follow the data point at index 3—the data points at indexes 4 and 5—to the first excursion 802, before stopping once the conformant data point at index 6 is reached. (block 710).

The subroutine 700 then stores the new excursion, and returns to block 702 to search for the next non-conformant data point, starting at index 6 (the data point that consecutively follows the last non-conformant data point added to the new excursion, per block 712). The next non-conformant data point is then found at index 9, and another new excursion (second excursion 804) is created. The consecutive non-conformant data point at index 10 is added to the second excursion 804 before reaching the conformant data point at index 11 and returning to block 702. After searching from index 11, no more non-conformant data points are found, and so the subroutine 700 proceeds to block 714 to store the set of excursions.

To process the second set of labeled data points 814 illustrated in FIG. 8B, the subroutine 700 again searches from the start of the set and searches sequentially until a non-conformant data point is found at index 2. A new excursion (first excursion 806) is created, and the data point at index 1 is added to the new excursion. The subroutine 700 then adds consecutive non-conformant data points that follow the data point at index 2—the data points from index 3 to index 11—to the first excursion 806, before stopping because the maximum excursion size has been reached (block 710).

The subroutine 700 then stores the first excursion 806, and returns to search for the next non-conformant data point, starting at index 12 since the data point at index 11 was the last data point added to the first excursion 806. The data point at index 12 is itself non-conformant, and so the subroutine 700 creates a second excursion 808, and adds the data point at index 12 to the second excursion 808 along with the consecutive non-conformant data point that follows it (index 13) before reaching the conformant data point at index 14. Again, the subroutine 700 stores the second excursion 808, and returns to search for the next non-conformant data point, starting at index 14.

The next non-conformant data point is found at index 15. The subroutine 700 creates a third excursion 810 for the data point at index 15, and stores the third excursion 810 as it has reached the end of the second set of labeled data points 814.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer-implemented method of efficiently and accurately monitoring aggregate conformance with operational intents for a fleet of unmanned aerial vehicles (UAVs), the method comprising:
receiving, by a computing system, telemetry data and operational intents for a plurality of flights during a monitoring period;
for each flight of the plurality of flights:
comparing, by the computing system, the telemetry data associated with the flight to the operational intent associated with the flight;
based on the comparing, labeling, by the computing system, each data point of the telemetry data as conformant or non-conformant; and
generating, by the computing system, a set of excursions based on the labeled data points;
determining, by the computing system, a level of aggregate conformance based on the set of excursions; and
performing, by the computing system, one or more actions in response to the level of aggregate conformance.

2. The computer-implemented method of claim 1, wherein generating the set of excursions based on the labeled data points includes:
detecting, by the computing system, a first non-conformant data point of the telemetry data;
adding, by the computing system, a first new excursion to the set of excursions;
adding, by the computing system, the first non-conformant data point to the first new excursion;
finding, by the computing system, one or more consecutive non-conformant data points that consecutively follow the first non-conformant data point, such that the first non-conformant data point and the one or more consecutive non-conformant data points are together less than or equal to a maximum excursion size; and
adding, by the computing system, the first non-conformant data point and the one or more consecutive non-conformant data points to the first new excursion.

3. The computer-implemented method of claim 2, wherein generating the set of excursions based on the labeled data points further includes:
searching, by the computing system, for a next non-conformant data point of the labeled data points starting with a data point that consecutively follows the last non-conformant data point added to the new excursion; and
in response to finding a next non-conformant data point of the labeled data points, adding, by the computing system, a second new excursion to the set of excursions that starts with the next non-conformant data point.

4. The computer-implemented method of claim 1, wherein determining the level of aggregate conformance based on the set of excursions includes:
determining, by the computing system, a total number of flight hours indicated by at least one of the operational intents or the telemetry data;
determining, by the computing system, a flight time conformance percentage and a per-flight-hour excursion number; and
determining, by the computing system, the level of aggregate conformance based on the flight time conformance percentage and the per-flight-hour excursion number.

5. The computer-implemented method of claim 4, wherein determining the flight time conformance percentage includes:
determining, by the computing system, a total duration of the excursions in the sets of excursions; and
dividing, by the computing system, the total duration of the excursions by the total number of flight hours to determine the flight time conformance percentage.

6. The computer-implemented method of claim 4, wherein determining the per-flight-hour excursion number includes:
counting, by the computing system, a total number of excursions in the sets of excursions; and
dividing, by the computing system, the total number of excursions by the total number of flight hours to determine the per-flight hour excursion number.

7. The computer-implemented method of claim 4, wherein determined level of aggregate conformance is one of an over-conformance level, a conformance level, a near non-conformance level, and a non-conformance level; and
wherein determining the level of aggregate conformance based on the flight time conformance percentage and the per-flight-hour excursion number includes:
comparing, by the computing system, the flight time conformance percentage to a set of percentage thresholds associated with the over-conformance level, the conformance level, the near non-conformance level, and the non-conformance level;
comparing, by the computing system, the per-flight-hour excursion number to a set of number thresholds associated with the over-conformance level, the conformance level, the near non-conformance level, and the non-conformance level; and
determining the level of aggregate conformance to be a lowest level of aggregate conformance indicated by the comparisons.

8. The computer-implemented method of claim 7, wherein the determined level of aggregate conformance is the near non-conformance level or the non-conformance level; and
wherein the one or more actions include:
presenting, by the computing system, a notification of the determined level of aggregate conformance to an operator.

9. The computer-implemented method of claim 7, wherein the determined level of aggregate conformance is the non-conformance level; and
wherein the actions include:
determining, by the computing system, an amount of time for which the non-conformance level has persisted; and
in response to determining, by the computing system, that the non-conformance level has persisted for more than a threshold amount of time, automatically preventing further flights by the fleet of UAVs.

10. The computer-implemented method of claim 1, wherein the actions include presenting a dashboard of historical determinations of levels of aggregate conformance.

11. A non-transitory computer-readable medium having logic stored thereon that, in response to execution by one or more processors of a computing system, causes the computing system to perform actions for efficiently and accurately monitoring aggregate conformance with operational intents for a fleet of unmanned aerial vehicles (UAVs), the actions comprising:
receiving, by the computing system, telemetry data and operational intents for a plurality of flights during a monitoring period;
for each flight of the plurality of flights:
comparing, by the computing system, the telemetry data associated with the flight to the operational intent associated with the flight;
based on the comparing, labeling, by the computing system, each data point of the telemetry data as conformant or non-conformant; and
generating, by the computing system, a set of excursions based on the labeled data points;
determining, by the computing system, a level of aggregate conformance based on the set of excursions; and
performing, by the computing system, one or more actions in response to the level of aggregate conformance.

12. The non-transitory computer-readable medium of claim 11, wherein generating the set of excursions based on the labeled data points includes:
detecting, by the computing system, a first non-conformant data point of the telemetry data;
adding, by the computing system, a first new excursion to the set of excursions;
adding, by the computing system, the first non-conformant data point to the first new excursion;
finding, by the computing system, one or more consecutive non-conformant data points that consecutively follow the first non-conformant data point, such that the first non-conformant data point and the one or more consecutive non-conformant data points are together less than or equal to a maximum excursion size; and
adding, by the computing system, the first non-conformant data point and the one or more consecutive non-conformant data points to the first new excursion.

13. The non-transitory computer-readable medium of claim 12, wherein generating the set of excursions based on the labeled data points further includes:
searching, by the computing system, for a next non-conformant data point of the labeled data points starting with a data point that consecutively follows the last non-conformant data point added to the new excursion; and
in response to finding a next non-conformant data point of the labeled data points, adding, by the computing system, a second new excursion to the set of excursions that starts with the next non-conformant data point.

14. The non-transitory computer-readable medium of claim 11, wherein determining the level of aggregate conformance based on the set of excursions includes:
determining, by the computing system, a total number of flight hours indicated by at least one of the operational intents or the telemetry data;
determining, by the computing system, a flight time conformance percentage and a per-flight-hour excursion number; and
determining, by the computing system, the level of aggregate conformance based on the flight time conformance percentage and the per-flight-hour excursion number.

15. The non-transitory computer-readable medium of claim 14, wherein determining the flight time conformance percentage includes:
determining, by the computing system, a total duration of the excursions in the sets of excursions; and
dividing, by the computing system, the total duration of the excursions by the total number of flight hours to determine the flight time conformance percentage.

16. The non-transitory computer-readable medium of claim 14, wherein determining the per-flight-hour excursion number includes:
counting, by the computing system, a total number of excursions in the sets of excursions; and
dividing, by the computing system, the total number of excursions by the total number of flight hours to determine the per-flight hour excursion number.

17. The non-transitory computer-readable medium of claim 14, wherein determined level of aggregate conformance is one of an over-conformance level, a conformance level, a near non-conformance level, and a non-conformance level; and
wherein determining the level of aggregate conformance based on the flight time conformance percentage and the per-flight-hour excursion number includes:
comparing, by the computing system, the flight time conformance percentage to a set of percentage thresholds associated with the over-conformance level, the conformance level, the near non-conformance level, and the non-conformance level;
comparing, by the computing system, the per-flight-hour excursion number to a set of number thresholds associated with the over-conformance level, the conformance level, the near non-conformance level, and the non-conformance level; and
determining the level of aggregate conformance to be a lowest level of aggregate conformance indicated by the comparisons.

18. The non-transitory computer-readable medium of claim 17, wherein the determined level of aggregate conformance is the near non-conformance level or the non-conformance level; and
wherein the one or more actions in response to the level of aggregate conformance include:
presenting, by the computing system, a notification of the determined level of aggregate conformance to an operator.

19. The non-transitory computer-readable medium of claim 17, wherein the determined level of aggregate conformance is the non-conformance level; and
wherein the actions in response to the level of aggregate conformance include:
determining, by the computing system, an amount of time for which the non-conformance level has persisted; and
in response to determining, by the computing system, that the non-conformance level has persisted for more than a threshold amount of time, automatically preventing further flights by the fleet of UAVs.

20. The non-transitory computer-readable medium of claim 11, wherein the actions in response to the level of aggregate conformance include presenting a dashboard of historical determinations of levels of aggregate conformance.
